(19) United States
(12) Patent Application Publication
(10) Pub. No.: US 2025/0162410 A1
(43) Pub. Date: May 22, 2025

(54) REACTION FORCE IMPARTING DEVICE

(71) Applicant: DENSO CORPORATION, Kariya-city (JP)

(72) Inventors: Yushi TSUZUKI, Kariya-city (JP); Noriyuki INAGAKI, Kariya-city (JP)

(21) Appl. No.: 19/027,686

(22) Filed: Jan. 17, 2025

Related U.S. Application Data
(63) Continuation of application No. PCT/JP2023/033032, filed on Sep. 11, 2023.

(30) Foreign Application Priority Data
Sep. 30, 2022 (JP) 2022-159017

(51) Int. Cl. B60K 26/02

(52) U.S. Cl. CPC B60K 26/021; B60K 2026/023

(57) ABSTRACT

A reaction force imparting device includes an actuator, a power transmission unit, and a lever. The actuator generates a driving force when energized. The power transmission unit has a reduction gear that reduces the speed of the driving force from the actuator, and a shaft member connected to the reduction gear. The lever has one end connected to the shaft member and is rotated by the driving force from the actuator of which the speed is reduced by the reduction gear, and imparts the reaction force to the pedal against a driver's depressing force. The reduction gear and the lever are fastened to both ends of the shaft member by crimping.

### CROSS-REFERENCE TO RELATED APPLICATIONS

This application is a continuation application of International Patent Application No. PCT/JP2023/033032 filed on Sep. 11, 2023, which designated the U.S. and based on and claims the benefits of priority of Japanese Patent Application No. 2022-159017 filed on Sep. 30, 2022. The entire disclosure of all of the above applications is incorporated herein by reference.

### TECHNICAL FIELD

The present disclosure relates to a reaction force imparting device.

### BACKGROUND

Conventionally, there has been known a reaction force imparting device that imparts a reaction force against a driver's depression force to a pedal of an accelerator device that includes a pedal that is depressed by a driver.

### SUMMARY

An object of the present disclosure is to provide a reaction force imparting device with a simple configuration.

The present disclosure relates to a reaction force imparting device capable of imparting a reaction force against a driver's depressing force to a pedal of an accelerator device having a pedal depressed by a driver. The reaction force imparting device includes an actuator, a power transmission unit, and a lever. The actuator generates a driving force when energized. The power transmission unit has a reduction gear that reduces a speed of the driving force from the actuator, and a shaft member that is connected to the reduction gear. The lever has one end connected to a shaft member, and is rotated by a driving force from the actuator that is reduced in speed by a reduction gear, and is capable of imparting the reaction force to the pedal or to an arm that rotates together with the pedal.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a reaction force imparting device of a first embodiment and an accelerator device to which the same is applied;

FIG. 2 is a perspective view showing the reaction force imparting device of the first embodiment and an accelerator device to which the same is applied;

FIG. 3 is a cross-sectional view showing the reaction force imparting device of the first embodiment;

FIG. 4 is a cross-sectional view showing a part of the reaction force imparting device of the first embodiment;

FIG. 5 is a perspective view showing a state of a crimping and fastening process of members constituting the reaction force imparting device of the first embodiment;

FIG. 6 is a diagram showing a part of the reaction force imparting device of the first embodiment;

FIG. 7 is a cross-sectional view showing a state of a crimping and fastening process of members constituting the reaction force imparting device of the first embodiment;

FIG. 8 is a diagram showing a reaction force imparting device of a second embodiment and an accelerator device to which the same is applied;

FIG. 9 is a perspective view showing a reaction force imparting device of a second embodiment and an accelerator device to which the same is applied;

FIG. 10 is a cross-sectional view showing a part of a reaction force imparting device according to a third embodiment;

FIG. 11 is a cross-sectional view showing a part of a reaction force imparting device according to a fourth embodiment;

FIG. 12 is a cross-sectional view showing a part of a reaction force imparting device according to a fifth embodiment, illustrating a state before being fastened by crimping;

FIG. 13 is a cross-sectional view showing a part of the reaction force imparting device of the fifth embodiment, illustrating a state after crimping; and

FIG. 14 is a diagram showing a part of a reaction force imparting device according to a sixth embodiment.

### DETAILED DESCRIPTION

In an assumable example, there has been known a reaction force imparting device that imparts a reaction force against a driver's depression force to a pedal of an accelerator device that includes a pedal that is depressed by a driver. For example, the reaction force imparting device includes a lever capable of imparting a reaction force to a pedal of the accelerator device against the depressing force of the driver. The reaction force imparting device also includes a reduction gear that reduces the speed of the driving force from an actuator, and a shaft member having one end connected to the reduction gear and the other end connected to a lever.

In the reaction force imparting device, one end of the shaft member and the lever are fastened together by a nut. Therefore, the reaction force imparting device may have a large number of components and may have a complicated configuration. Furthermore, there is a risk that the lever may fall off the shaft member due to the nut becoming loose.

An object of the present disclosure is to provide a reaction force imparting device with a simple configuration.

The present disclosure relates to a reaction force imparting device capable of imparting a reaction force against a driver's depressing force to a pedal of an accelerator device having a pedal depressed by a driver. The reaction force imparting device includes an actuator, a power transmission unit, and a lever. The actuator generates a driving force when energized. The power transmission unit has a reduction gear that reduces a speed of the driving force from the actuator, and a shaft member that is connected to the reduction gear. The lever has one end connected to a shaft member, and is rotated by a driving force from the actuator that is reduced in speed by a reduction gear, and is capable of imparting the reaction force to the pedal or to an arm that rotates together with the pedal.

The reduction gear and the lever are fastened to both ends of the shaft member by crimping. Therefore, the number of components of the reaction force imparting device can be reduced, and the configuration can be simplified.

Hereinafter, a reaction force imparting device according to a plurality of embodiments and an accelerator device to which the same is applied will be described based on the drawings. Components that are substantially the same in the plurality of embodiments are denoted by the same reference numerals and will not be described.

### First Embodiment

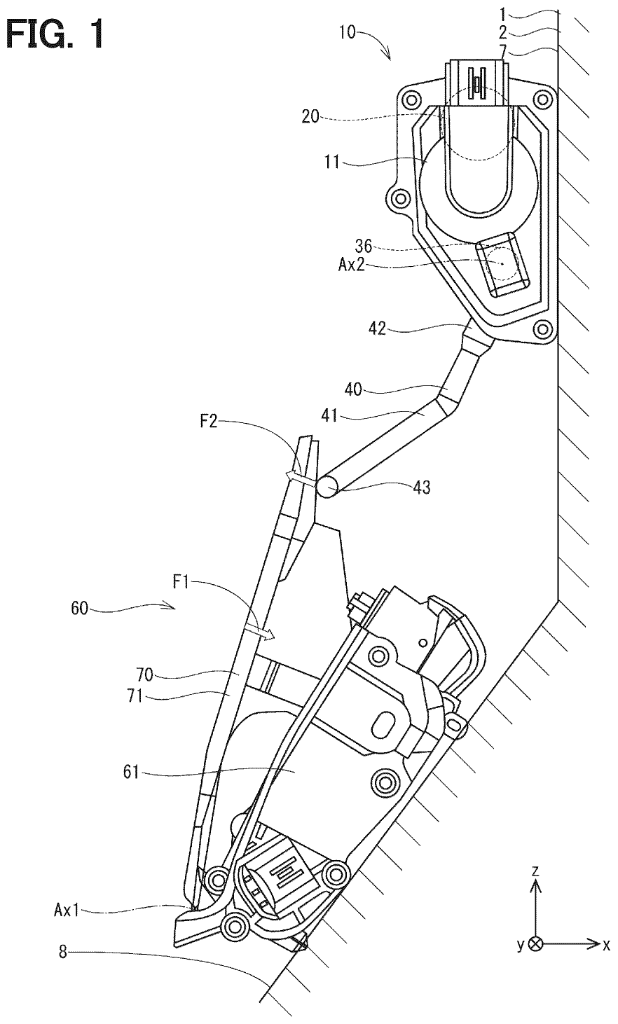

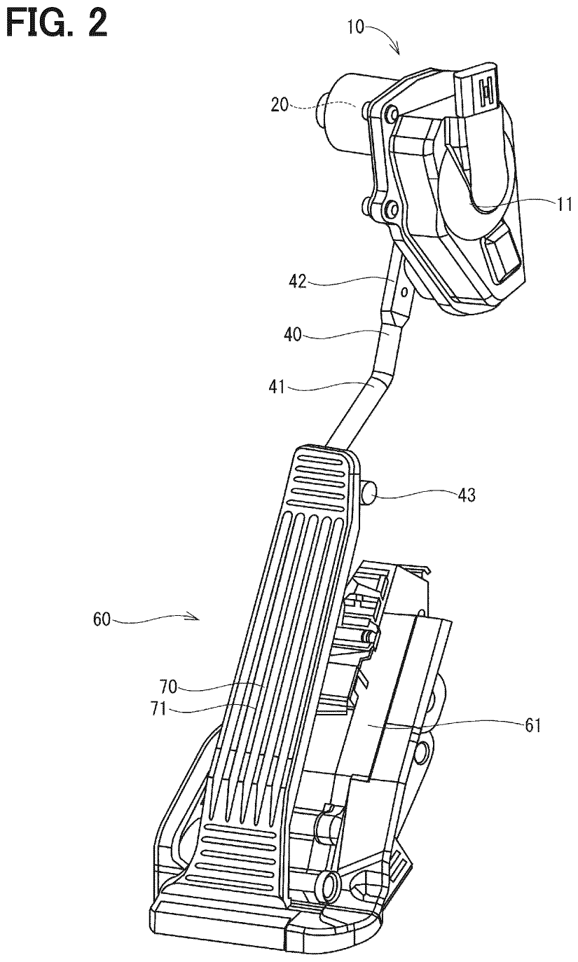

A reaction force imparting device according to a first embodiment and an accelerator device to which the same is applied are shown in FIGS. 1 and 2.

The accelerator device 60 is mounted on a vehicle 1 and is used to control a driving state of the vehicle 1 by detecting an accelerator opening degree corresponding to a rotation angle of a pedal 70 depressed by a driver. The accelerator device 60 employs an accelerator-by-wire system and is not mechanically connected to a throttle device of the vehicle 1. The accelerator device 60 transmits information regarding the accelerator opening degree corresponding to the rotation angle of the pedal 70 to an electronic control unit (hereinafter referred to as “ECU”), not shown. The ECU controls the throttle device based on the accelerator opening degree transmitted from the accelerator device 60. Thereby, a running state of the vehicle 1 is controlled.

The reaction force imparting device 10 is mounted on the vehicle 1 together with the accelerator device 60, and can impart a reaction force F2 to the pedal 70 of the accelerator device 60 in response to the driver's depression force F1. By imparting a reaction force to the pedal 70 of the accelerator device 60, the reaction force imparting device 10 can provide a driver notification such as a danger notification or a fuel efficiency improvement notification to the driver. Further, the reaction force imparting device 10 can use the pedal 70 as a footrest by regulating the rotation of the pedal 70.

In FIG. 1, an x-axis indicates a traveling direction of the vehicle 1, a y-axis indicates a width direction of the vehicle, and a z-axis indicates a vertically upward direction. Hereinafter, unless otherwise specified, the shape or configuration of the accelerator device 60 and the reaction force imparting device 10 in a state where they are attached to the vehicle 1 will be described. For example, the term “upward” or “upper side” means the upward or upper side of the accelerator device 60 or the reaction force imparting device 10 in a state where it is attached to the vehicle 1. In the present embodiment, the floor panel 2 has a wall surface 7 that is parallel to the yz plane, and a wall surface 8 that is inclined relative to the wall surface 7.

The accelerator device 60 includes a pedal housing 61, a pedal 70, and the like. The pedal housing 61 is attached to the floor panel 2 by being fixed to a wall surface 8 of the floor panel 2 of the vehicle 1 by, for example, attachment bolts (not shown).

The pedal 70 is rotatably supported by the pedal housing 61 so as to rotate around a rotation axis Ax1. The pedal 70 is provided with a pad 71 that is depressed by the driver. An accelerator opening degree sensor (not shown) is provided inside the pedal housing 61. The accelerator opening degree sensor detects the accelerator opening degree corresponding to the rotation angle of the pedal 70 rotated by the driver's depression operation, and transmits the detected accelerator opening degree to the ECU. The rotation axis Ax1 is set to be perpendicular to the z-axis and the x-axis, and parallel to the y-axis.

A pedal biasing member (not shown) is provided within the pedal housing 61. The pedal 70 is biased in the accelerator closing direction by a pedal biasing member. The pedal housing 61 has a stopper that restricts rotation of the pedal 70 in an accelerator closing direction and a stopper that restricts rotation of the pedal 70 in an accelerator opening direction. The pedal 70 is rotatable within a range in which it contacts both stoppers. FIG. 1 shows a state in which the pedal 70 is in contact with a stopper in the accelerator closing direction, that is, a state in which the accelerator is fully closed.

As shown in FIGS. 1 and 2, the reaction force imparting device 10 includes an actuator 20, a power transmission unit 30, and a lever 40. The actuator 20 generates a driving force when energized. The power transmission unit 30 has a reduction gear 31 that reduces the speed of the driving force from the actuator 20, a reduction gear 32, and a shaft member 36 that is connected to the reduction gear 32. The lever 40 has one end connected to the shaft member 36 and is rotated by the driving force from the actuator 20 that is reduced in speed by the reduction gears 31 and 32, and can imparting a reaction force to the pedal 70 against the driver's depressing force. The reduction gear 32 and the lever 40 are fastened to both ends of the shaft member 36 by crimping.

More specifically, the reaction force imparting device 10 includes an actuator housing 11. The actuator housing 11 is attached to the floor panel 2 by being fixed to a wall surface 7 of the floor panel 2 of the vehicle 1 by, for example, attachment bolts (not shown).

The actuator 20 is, for example, an electric motor, and is accommodated in the actuator housing 11. The actuator 20 is capable of outputting torque as a driving force when energized. The ECU is capable of controlling the supply of electricity to the actuator 20 and controlling the operation of the actuator 20. The actuator housing 11 is provided with a power transmission unit 30. The power transmission unit 30 is capable of reducing the torque of the actuator 20 and outputting it from the shaft member 36. The shaft member 36 is provided on the rotation axis Ax2 and supported by the actuator housing 11 so as to be rotatable around the rotation axis Ax2.

The lever 40 has a lever body 41, one end 42, the other end 43, etc. The lever body 41 is made of, for example, metal and has a rod-like shape. The one end 42 is connected to one end of the lever body 41 and is formed integrally with the lever body 41. The other end 43 of the lever is connected to the other end of the lever body 41 and is formed integrally with the lever body 41. The other end 43 of the lever is formed to be substantially perpendicular to the lever body 41. The other end 43 of the lever is arranged to be parallel to the y-axis.

The lever 40 is provided such that one end 42 of the lever is connected to the shaft member 36. As a result, the lever 40 is rotatably supported by the actuator housing 11 so as to rotate together with the shaft member 36 around the rotation axis Ax2. The lever 40 rotates around the rotation axis Ax2 due to the driving force from the actuator 20 outputted from the shaft member 36.

As shown in FIG. 1, the reaction force imparting device 10 is arranged so that an outer wall of the other end 43 of the lever can abut against the surface of the pedal 70 of the accelerator device 60 on the floor panel 2 side, and can be separated from the surface of the pedal 70 on the floor panel 2 side. As a result, the reaction force imparting device 10 can apply a reaction force F2 to the pedal 70 from the lever 40, which rotates by the driving force from the actuator 20, in response to a depression force F1 applied by the driver.

The configuration of the reaction force imparting device 10 will be described in more detail below.

The actuator housing 11 has a first housing 12 and a second housing 13. The first housing 12 is made of, for example, a metal. The second housing 13 is formed from, for example, resin. The first housing 12 and the second housing 13 have openings that abut against each other to form a space therein capable of accommodating members and the like. The first housing 12 and the second housing 13 are connected by bolts 14.

The actuator 20 is provided on the first housing 12 side within the actuator housing 11. The actuator 20 has a shaft 21 and a pinion gear 22. The shaft 21 is provided so that one end thereof is connected to a rotor (not shown) and is capable of outputting the driving force of the actuator 20. The pinion gear 22 is provided on the other end of the shaft 21. The pinion gear 22 has external teeth on its outer circumferential wall.

The reduction gear 31 of the power transmission unit 30 is provided on the second housing 13 side within the actuator housing 11. The reduction gear 31 is made of, for example, resin, and has a large diameter gear 311 and a small diameter gear 312. The large diameter gear 311 is formed in an annular shape and has external teeth on its outer circumferential wall. The small diameter gear 312 is formed so as to extend in a cylindrical shape from an inner edge portion of the large diameter gear 311. The outer diameter of the small diameter gear 312 is smaller than the outer diameter of the large diameter gear 311. The small diameter gear 312 has external teeth formed on its outer circumferential wall.

The first housing 12 is provided with a gear shaft 15. The gear shaft 15 is supported by the first housing 12 via a bearing 16 provided in the first housing 12 so as to be rotatable about its axis.

The reduction gear 31 is provided on the gear shaft 15 so that the external teeth of the large diameter gear 311 mesh with the external teeth of the pinion gear 22. The reduction gear 31 is press-fitted onto the gear shaft 15 so that the inner peripheral wall of the small diameter gear 312 fits into the outer peripheral wall of the gear shaft 15. As a result, the reduction gear 31 is supported by the first housing 12 so as to be rotatable around the axis within the actuator housing 11. When the actuator 20 rotates, the pinion gear 22 rotates, and the reduction gear 31 also rotates.

The reduction gear 32 has a gear fitting hole 34 into which one end of the shaft member 36 fits. The lever 40 has a lever fitting hole 44 into which the other end of the shaft member 36 fits. In a cross section perpendicular to the axial direction of the shaft member 36, the shape of one end of the shaft member 36 and the gear fitting hole 34, and the shape of the other end of the shaft member 36 and the lever fitting hole 44 are non-circular.

One end of the shaft member 36 and the gear fitting hole 34, and the other end of the shaft member 36 and the lever fitting hole 44 have at least one flat surface at locations facing each other.

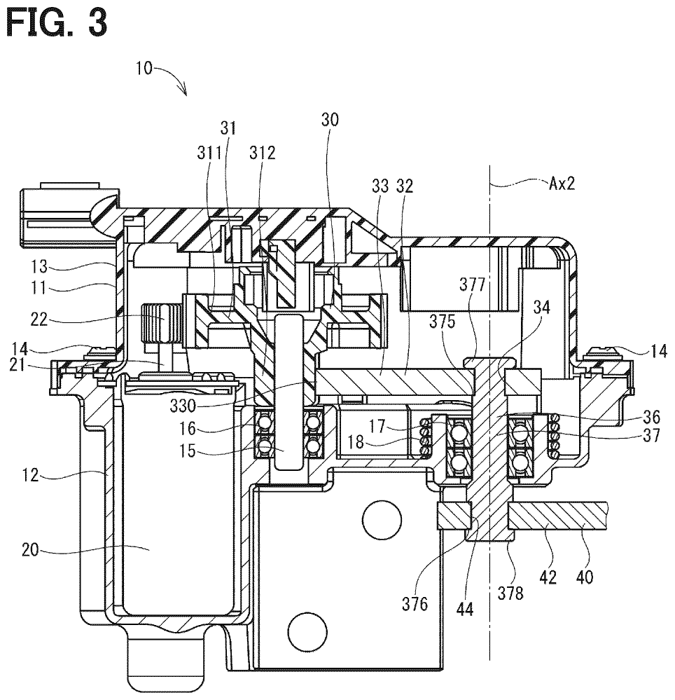

More specifically, the reduction gear 32 is provided between the first housing 12 and the second housing 13 within the actuator housing 11. The reduction gear 32 has a gear body 33, a gear fitting hole 34 as a fitting hole, and the like. The gear body 33 is made of, for example, metal and is formed into a substantially rectangular plate shape (see FIGS. 3 and 5). External teeth 330 are formed on one end of the gear body 33 in the longitudinal direction. The gear fitting hole 34 is formed at the end side of the gear body 33 opposite the external teeth 330 so as to penetrate the gear body 33 in a plate thickness direction.

The shaft member 36 is made of, for example, metal and has a rod-like shape. The shaft member 36 is supported by the first housing 12 via a bearing 17 provided in the first housing 12 so as to be rotatable about its axis.

The reduction gear 32 is provided on the shaft member 36 so that the external teeth 330 mesh with the external teeth of the small diameter gear 312 of the reduction gear 31. The reduction gear 32 is provided non-rotatably relative to the shaft member 36 such that the inner wall of the gear fitting hole 34 fits into the outer wall of one end of the shaft member 36. As a result, when the actuator 20 rotates, the reduction gear 31 rotates, the reduction gear 32 rotates, and the shaft member 36 also rotates.

The lever 40 has a lever fitting hole 44 as a fitting hole. The one end 42 of the lever is formed in a long plate shape. The lever fitting hole 44 is formed at the end side of one end 42 of the lever opposite the lever body 41 so as to penetrate one end 42 in the plate thickness direction.

The lever 40 is provided on the shaft member 36 so as not to rotate relatively thereto, with the inner wall of the lever fitting hole 44 fitting into the outer wall of the other end of the shaft member 36. As a result, when the actuator 20 rotates, the reduction gear 31 rotates, the reduction gear 32 rotates, the shaft member 36 rotates, and the lever 40 also rotates. Therefore, the lever 40 is rotated by the driving force of the actuator 20, and is able to impart a reaction force F2 to the pedal 70 in response to the depression force F1 applied by the driver.

In the present embodiment, a spring 18 is provided in the first housing 12 within the actuator housing 11. The spring 18 is, for example, a coil spring, and is provided radially outside the shaft member 36. The spring 18 biases the reduction gear 32 or the shaft member 36 so that the lever 40 rotates in a direction in which the other end 43 of the lever abuts against the pedal 70.

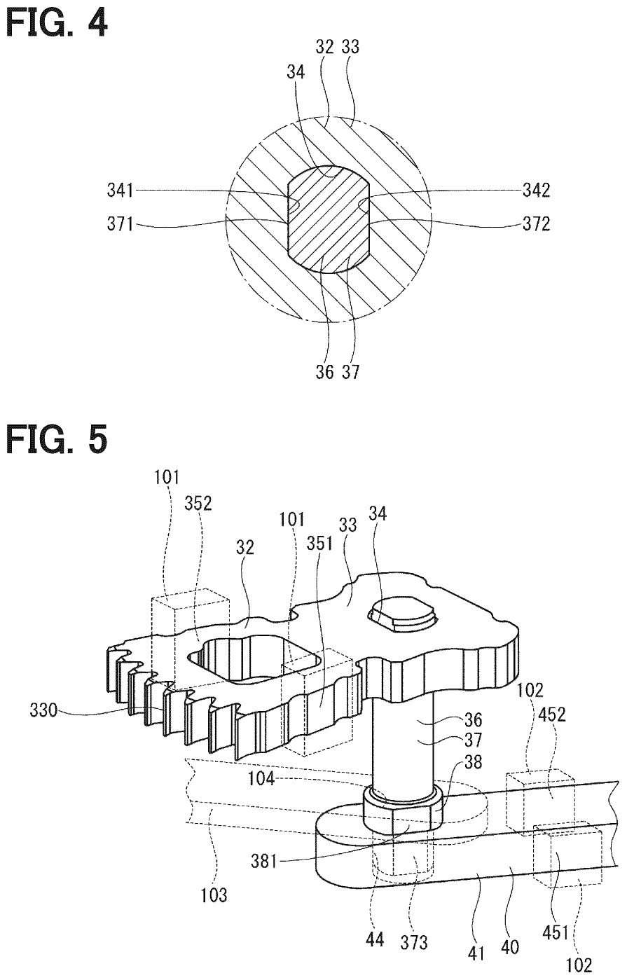

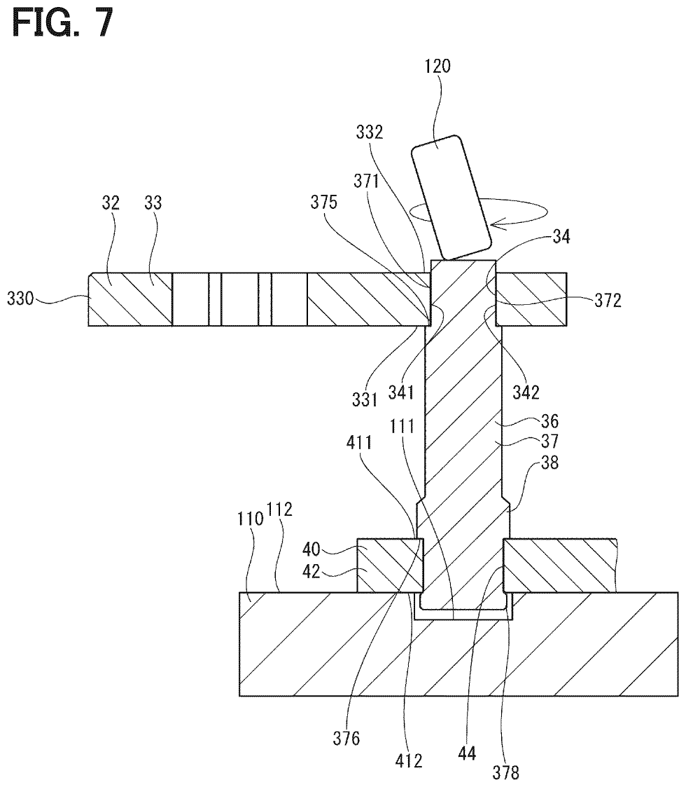

The shaft member 36 has a main shaft portion 37 (see FIG. 7). The main shaft portion 37 is formed in a substantially cylindrical shape. One end of the main shaft portion 37 is formed with flat surfaces 371 and 372 (see FIGS. 4 and 7). The flat surfaces 371 and 372 are formed to be parallel to each other with the axis of the main shaft portion 37 therebetween. The gear fitting hole 34 has flat surfaces 341 and 342 (see FIGS. 4 and 7). The flat surfaces 341 and 342 are formed to be parallel to each other with the axis of the gear fitting hole 34 therebetween. In this manner, one end of the shaft member 36 and the gear fitting hole 34 have at least one flat surface at locations facing each other.

One end of the shaft member 36 and the gear fitting hole 34 are fitted together such that the flat surface 371 faces the flat surface 341 and the flat surface 372 faces the flat surface 342 (see FIGS. 4 and 7). This restricts the relative rotation between the shaft member 36 and the reduction gear 32. Thus, in a cross section perpendicular to the axial direction of the shaft member 36, the shape of one end of the shaft member 36 and the gear fitting hole 34 is non-circular.

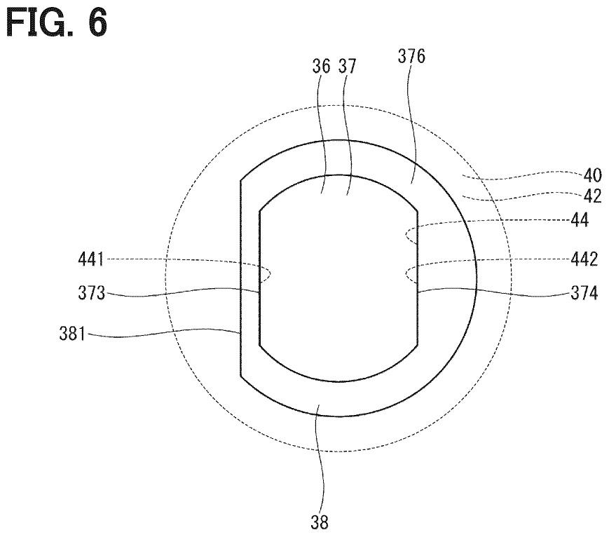

The other end of the main shaft portion 37 is formed with flat surfaces 373 and 374 (see FIGS. 5 and 6). The flat surfaces 373 and 374 are formed to be parallel to each other with the axis of the main shaft portion 37 therebetween. The lever fitting hole 44 has flat surfaces 441 and 442 (see FIG. 6). The flat surfaces 441 and 442 are formed so as to be parallel to each other with the axis of the lever fitting hole 44 therebetween. In this manner, the other end of the shaft member 36 and the lever fitting hole 44 have at least one flat surface at locations facing each other.

The other end of the shaft member 36 and the lever fitting hole 44 are fitted together such that the flat surfaces 373 and 441 face each other, and the flat surfaces 374 and 442 face each other (see FIG. 6). This restricts the relative rotation between the shaft member 36 and the lever 40. Thus, in a cross section perpendicular to the axial direction of the shaft member 36, the other end of the shaft member 36 and the lever fitting hole 44 have a non-circular shape.

In this manner, the cross section of the fitting portion between the shaft member 36 and the reduction gear 32 or the lever 40 is non-circular. The fitting portion has at least one flat surface at a portion facing the shaft member 36 and the reduction gear 32 or the lever 40.

At least one of the reduction gear 32 and the lever 40 has a rotation restricting portion that can restrict rotation of the reduction gear 32 or the lever 40 by abutting against a jig when a rotational force around the axis acts on the shaft member 36.

More specifically, the reduction gear 32 has a rotation restricting portion 351 and a rotation restricting portion 352. The rotation restricting portions 351 and 352 are formed on both side surfaces in the plate surface direction at an end portion of the gear body 33 on the external teeth 330 side (see FIG. 5). By abutting the jig 101 against the rotation restricting portions 351 and 352, the rotation of the reduction gear 32 can be restricted even if a rotational force around the axis acts on the shaft member 36.

The lever 40 has a rotation restricting portion 451 and a rotation restricting portion 452. The rotation restricting portions 451 and 452 are formed on both side surfaces of the one end 42 of the lever in the plate surface direction (see FIG. 5). By abutting the jig 102 against the rotation restricting portions 451 and 452, the rotation of the lever 40 can be restricted even if a rotational force around the axis acts on the shaft member 36.

The shaft member 36 has a shaft member rotation restricting portion 38 at a portion other than both ends in the axial direction, which is capable of restricting the rotation of the shaft member 36 by abutting against the jig when a rotational force around the axis acts on the shaft member 36.

The shaft member rotation restricting portion 38 is formed into a D-cut shape.

More specifically, the shaft member rotation restricting portion 38 is formed in a cylindrical shape so as to protrude toward the flat surfaces 371 and 372 with respect to the flat surfaces 373 and 374, namely, radially outward from the outer peripheral wall between one end and the other end of the main shaft portion 37 (see FIGS. 5 to 7). A flat surface 381 is formed on a portion of the outer circumferential wall of the shaft member rotation restricting portion 38 in the circumferential direction. As a result, the shaft member rotation restricting portion 38 is formed into a D-cut shape, that is, a D-shaped outline when viewed from the axial direction (see FIG. 6).

By preparing a jig 103 having a jig hole portion 104 shaped to correspond to the outer shape of the shaft member rotation restricting portion 38 and engaging this jig hole portion 104 with the shaft member rotation restricting portion 38, the rotation of the shaft member 36 can be restricted even if a rotational force around the axis acts on the shaft member 36 (see FIG. 5).

The shaft member 36 has a seat surface that abuts against the reduction gear 32 or the lever 40 in the axial direction. The reduction gear 32 or the lever 40 has a first flat surface that abuts against the seat surface, and a second flat surface that is parallel to the first flat surface.

More specifically, the shaft member 36 has a seat surface 375 and a seat surface 376. The seat surface 375 is formed as a flat surface on the shaft member rotation restricting portion 38 side of each of the flat surfaces 371 and 372 so as to face the opposite side to the shaft member rotation restricting portion 38 (see FIG. 7). The seat surface 376 is formed in an annular, planar shape on the opposite side to the seat surface 375 of the shaft member rotation restricting portion 38 so as to face the opposite side to the seat surface 375 (see FIGS. 6 and 7).

The reduction gear 32 has a first flat surface 331 and a second flat surface 332. The first flat surface 331 is formed in an annular shape around the gear fitting hole 34 on one end face of the gear body 33 so as to abut against the seat surface 375 (see FIG. 7). The second flat surface 332 is formed in an annular shape around the gear fitting hole 34 on the other end face of the gear body 33 so as to be parallel to the first flat surface 331.

The lever 40 has a first flat surface 411 and a second flat surface 412. The first flat surface 411 is formed in an annular shape around the lever fitting hole 44 on one end face of the one end 42 of the lever so as to abut against the seat surface 376 (see FIG. 7). The second flat surface 412 is formed in an annular shape around the lever fitting hole 44 on the other end face of the one end 42 of the lever so as to be parallel to the first flat surface 411.

As shown in FIG. 3, the shaft member 36 has a crimped portion 377 and a crimped portion 378. The crimped portion 377 is formed by crimping so as to expand radially outward from one end of the main shaft portion 37. The crimped portion 377 holds the reduction gear 32 by sandwiching the gear body 33 between itself and the seat surface 375. In this manner, by fastening the reduction gear 32 to one end of the shaft member 36 by crimping, it is possible to prevent the reduction gear 32 from falling off the shaft member 36.

The crimped portion 378 is formed by crimping so as to expand radially outward from the other end of the main shaft portion 37. The crimped portion 378 holds the lever 40 by sandwiching the one end 42 of the lever between itself and the seat surface 376. In this manner, by fastening the lever 40 to the other end of the shaft member 36 by crimping, it is possible to prevent the lever 40 from falling off the shaft member 36.

Next, the crimping fastening of the reduction gear 32 to the shaft member 36 will be described.

FIG. 7 shows a state in which the lever 40 has already been fastened to the shaft member 36 by crimping.

First, the lever 40 and the shaft member 36 are positioned so that the crimped portion 378 is positioned in the base recess 111 formed in the base 110 and the second flat surface 412 of the lever 40 abuts against the upper surface 112 of the base 110. Next, the reduction gear 32 is disposed so that the gear fitting hole 34 fits onto one end of the shaft member 36. Next, the reduction gear 32, the lever 40 or the shaft member 36 is held by the jig 101, the jig 102 or the jig 103 (see FIG. 5).

Next, the punch 120 is brought into contact with one end of the shaft member 36 and rotated while pressing it toward the base 110. As a result, the crimped portion 377 is formed at one end of the shaft member 36, and the crimping fastening of the reduction gear 32 to the shaft member 36 is completed.

In the present embodiment, in a state where the crimped portion 378 is located in the base recess 111 and the second flat surface 412 of the lever 40 abuts against the upper surface 112 of the base 110, the punch 120 presses the shaft member 36 toward the base 110. Therefore, the load of the punch 120 acts on the upper surface 112 of the base 110 via the seat surface 376, the first flat surface 411, and the second flat surface 412. This makes it possible to prevent the load of the punch 120 from acting on the crimped portion 378. Therefore, during the crimping process using the punch 120, deformation or damage to the already formed crimped portion 378 can be suppressed.

In addition, in the case where the crimped portion 377 is formed first and then the crimped portion 378 is formed using the punch 120, the reduction gear 32 and the shaft member 36 are positioned so that the crimped portion 377 is positioned in the base recess 111 and the second flat surface 332 of the reduction gear 32 abuts against the upper surface 112 of the base 110, and the punch 120 is abutted against the other end of the shaft member 36 and rotated while being pressed toward the base 110. In this case, the load of the punch 120 acts on the upper surface 112 of the base 110 via the seat surface 375, the first flat surface 331, and the second flat surface 332. This makes it possible to prevent the load of the punch 120 from acting on the crimped portion 377.

As described above, in the present embodiment, the power transmission unit 30 has a reduction gear 31 that reduces the speed of the driving force from the actuator 20, a reduction gear 32, and a shaft member 36 that is connected to the reduction gear 32. The lever 40 has one end connected to the shaft member 36 and is rotated by the driving force from the actuator 20 that is reduced in speed by the reduction gears 31 and 32, and can imparting a reaction force to the pedal 70 against the driver's depressing force. The reduction gear 32 and the lever 40 are fastened to both ends of the shaft member 36 by crimping.

Therefore, the number of components of the reaction force imparting device 10 can be reduced, and the configuration can be simplified. In addition, it is possible to prevent the lever from falling off the shaft member due to the nut loosening, which can occur in the reaction force applying device in Patent Document 1 (Japanese Patent No. 6634436).

In addition, in the present embodiment, the reduction gear 32 has a gear fitting hole 34 into which one end of the shaft member 36 fits. The lever 40 has a lever fitting hole 44 into which the other end of the shaft member 36 fits. In a cross section perpendicular to the axial direction of the shaft member 36, the shape of one end of the shaft member 36 and the gear fitting hole 34, and the shape of the other end of the shaft member 36 and the lever fitting hole 44 are non-circular.

Here, in a cross section perpendicular to the axial direction of the shaft member 36, it is desirable that the shape of one end of the shaft member 36 and the gear fitting hole 34, and the shape of the other end of the shaft member 36 and the lever fitting hole 44 are non-circular.

In the present embodiment, one end of the shaft member 36 and the gear fitting hole 34, and the other end of the shaft member 36 and the lever fitting hole 44 have at least one flat surface at locations facing each other.

Therefore, the relative rotation between the reduction gear 32 and the shaft member 36 can be restricted with a simple structure. Furthermore, the relative rotation between the lever 40 and the shaft member 36 can be restricted with a simple structure.

In the present embodiment, at least one of the reduction gear 32 and the lever 40 has a rotation restricting portion that can restrict rotation of the reduction gear 32 or the lever 40 by abutting against a jig when a rotational force around the axis acts on the shaft member 36.

Therefore, rotation of the shaft member 36 during crimping can be suppressed, improving manufacturing efficiency.

In the present embodiment, the shaft member 36 has a shaft member rotation restricting portion 38 at a portion other than both ends in the axial direction, which is capable of restricting the rotation of the shaft member 36 by abutting against the jig when a rotational force around the axis acts on the shaft member 36.

The shaft member rotation restricting portion 38 is formed into a D-cut shape.

Therefore, when the shaft member 36 is crimped, rotation of the shaft member 36 and other members fitted to the shaft member 36, such as the reduction gear 32 and the lever 40, can be suppressed, improving manufacturing efficiency. Furthermore, when the shaft member 36 is crimped, the rotation of the shaft member 36 itself can be restricted by the shaft member rotation restricting portion 38, so that the application of load to the fitting portion between the shaft member 36 and another member that fits onto the shaft member 36 can be suppressed. This makes it possible to prevent the fitting state between the shaft member 36 and the other member from deteriorating.

In the present embodiment, the shaft member 36 has a seat surface that abuts against the reduction gear 32 or the lever 40 in the axial direction. The reduction gear 32 or the lever 40 has a first flat surface that abuts against the seat surface, and a second flat surface that is parallel to the first flat surface.

Therefore, when the shaft member 36 is crimped, it is possible to avoid a load from acting on the already formed crimped portion, and deformation or damage to the crimped portion can be suppressed.

### Second Embodiment

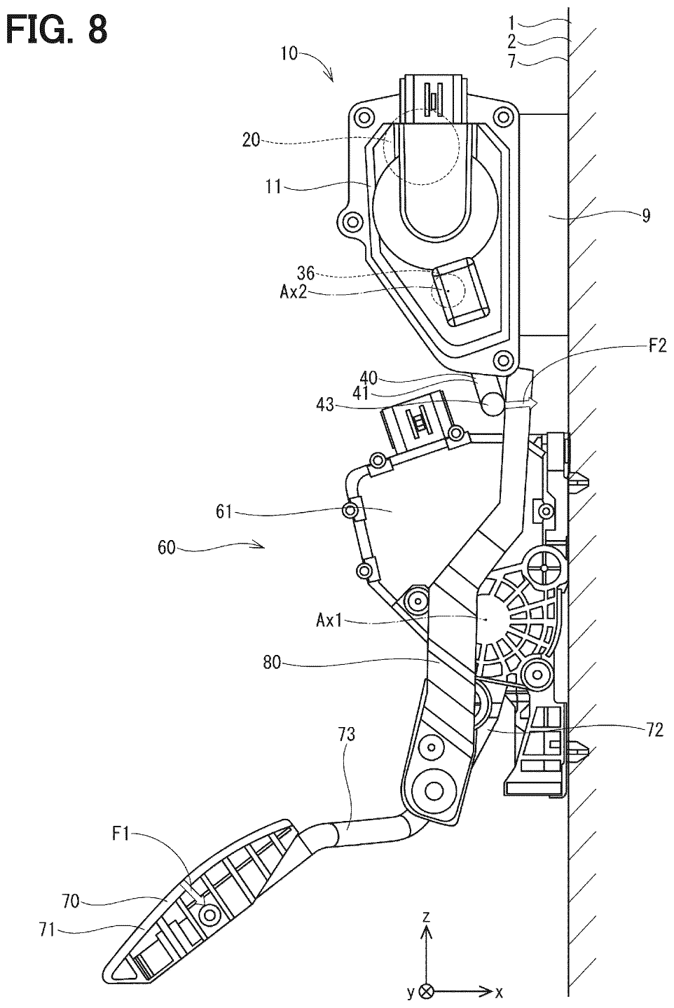

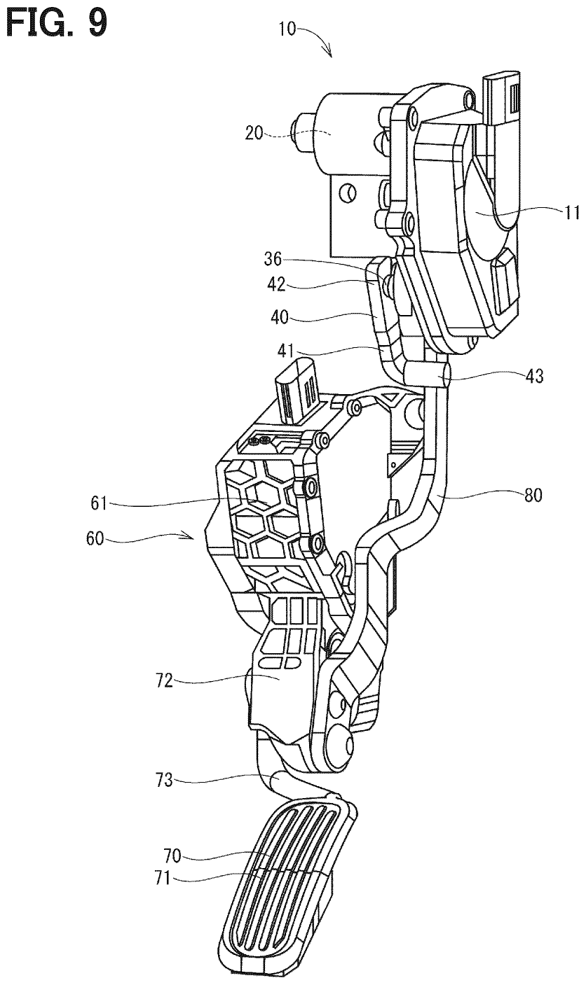

A reaction force imparting device according to a second embodiment and an accelerator device to which the same is applied are shown in FIGS. 8 and 9. The second embodiment differs from the first embodiment in the configurations of the reaction force imparting device 10 and the accelerator device 60.

In the present embodiment, the pedal housing 61 of the accelerator device 60 is attached to the floor panel 2 by being fixed to a wall surface 8 of the floor panel 2 of the vehicle 1 by, for example, attachment bolts (not shown).

The pedal 70 includes a pad 71, a pedal base portion 72, and a pedal connection portion 73. The pedal connection portion 73 is formed of, for example, metal, and connects the pad 71 and the pedal base portion 72 such that one end is connected to the pad 71 and the other end is connected to the pedal base portion 72. The pedal base portion 72 is rotatably supported by the pedal housing 61 so as to rotate around a rotation axis Ax1. This allows the pedal 70 to rotate around the rotation axis Ax1.

In the present embodiment, the accelerator device 60 further includes an arm 80. The arm 80 is formed, for example, by bending a long metal plate at a predetermined position (see FIG. 9). The arm 80 is attached to the pedal 70 with one end connected to the pedal base portion 72. This allows the arm 80 to rotate together with the pedal 70 around the rotation axis Ax1.

In the present embodiment, the actuator housing 11 of the reaction force imparting device 10 is attached to the floor panel 2 via the base 9 by being fixed to the base 9 provided on the wall surface 7 of the floor panel 2 of the vehicle 1, for example by a mounting bolt not shown.

In the reaction force imparting device 10 of the present embodiment, the length of the lever body 41 of the lever 40 is shorter than that of the first embodiment.

As shown in FIG. 8, the reaction force imparting device 10 is arranged so that the outer wall of the other end 43 of the lever can abut against the surface of the arm 80 of the accelerator device 60 opposite the floor panel 2, and can be separated from the surface of the arm 80 opposite the floor panel 2. As a result, the reaction force imparting device 10 can apply a reaction force F2 to the pedal 70 via the arm 80 from the lever 40, which rotates by the driving force from the actuator 20, in response to a depression force F1 applied by the driver.

The present embodiment is similar to the first embodiment except for the above-mentioned configurations. Therefore, for configurations similar to those in the first embodiment, the same effects as those in the first embodiment can be achieved (the same applies below).

### Third Embodiment

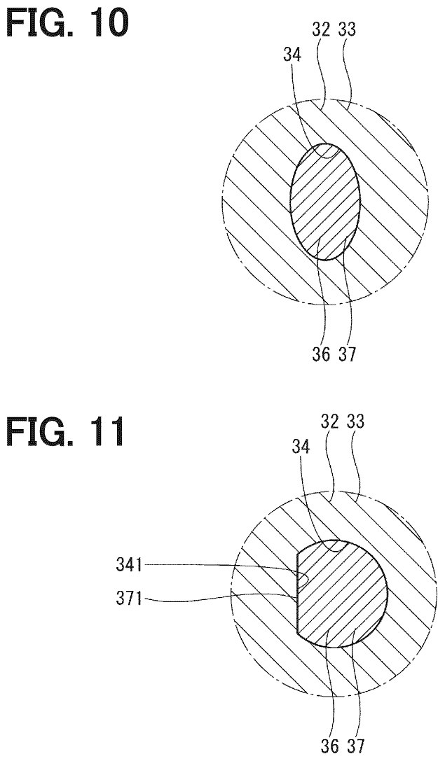

FIG. 10 shows a part of a reaction force imparting device according to a third embodiment. The third embodiment differs from the first embodiment in the configurations of the shaft member 36, the reduction gear 32, the lever 40, and the like.

In the present embodiment, the flat surfaces 371, 372, 373, and 374 shown in the first embodiment are not formed on the main shaft portion 37 (see FIGS. 4 and 10). In a cross section perpendicular to the axial direction of the shaft member 36, one end of the main shaft portion 37 has an elliptical shape (see FIG. 10). In addition, in a cross section perpendicular to the axial direction of shaft member 36, the shape of the other end of main shaft portion 37 is elliptical, similar to the shape of one end.

The gear fitting hole 34 does not have the flat surfaces 341 and 342 shown in the first embodiment (see FIGS. 4 and 10). In a cross section perpendicular to the axial direction of the shaft member 36, the gear fitting hole 34 has an elliptical shape (see FIG. 10). The shape of the gear fitting hole 34 corresponds to the shape of one end of the main shaft portion 37.

One end of the shaft member 36 is fitted into the gear fitting hole 34 such that the outer peripheral wall of the one end of the shaft member 36 faces the inner peripheral wall of the gear fitting hole 34 (see FIG. 10). This restricts the relative rotation between the shaft member 36 and the reduction gear 32. Thus, in a cross section perpendicular to the axial direction of the shaft member 36, the shape of one end of the shaft member 36 and the gear fitting hole 34 is not a perfect circle.

In the present embodiment, the lever fitting hole 44 does not have the flat surfaces 441 and 442. In a cross section perpendicular to the axial direction of the shaft member 36, the lever fitting hole 44 has an elliptical shape. The shape of the lever fitting hole 44 corresponds to the shape of the other end of the main shaft portion 37.

The other end of the shaft member 36 and the lever fitting hole 44 are fitted together such that the outer circumferential wall of the other end of the shaft member 36 and the inner circumferential wall of the lever fitting hole 44 face each other. This restricts the relative rotation between the shaft member 36 and the lever 40. Thus, in a cross section perpendicular to the axial direction of the shaft member 36, the shape of the other end of the shaft member 36 and the lever fitting hole 44 is not a perfect circle.

### Fourth Embodiment

FIG. 11 shows a part of the reaction force imparting device according to the fourth embodiment. The fourth embodiment differs from the first embodiment in the configurations of the shaft member 36, the reduction gear 32, the lever 40, and the like.

In the present embodiment, the flat surfaces 372 and 374 shown in the first embodiment are not formed on the main shaft portion 37 (see FIGS. 4 and 11). In a cross section perpendicular to the axial direction of the shaft member 36, one end of the main shaft portion 37 has a D-shape (see FIG. 11). In addition, in a cross section perpendicular to the axial direction of the shaft member 36, the shape of the other end of the main shaft portion 37 has D-shape, similar to the shape of the one end.

The gear fitting hole 34 does not have the flat surface 342 shown in the first embodiment (see FIGS. 4 and 11). In a cross section perpendicular to the axial direction of the shaft member 36, the gear fitting hole 34 has a D-shape (see FIG. 11). The shape of the gear fitting hole 34 corresponds to the shape of one end of the main shaft portion 37.

One end of the shaft member 36 and the gear fitting hole 34 are fitted together such that the flat surface 371 and the flat surface 341 face each other (see FIG. 11). This restricts the relative rotation between the shaft member 36 and the reduction gear 32. Thus, in a cross section perpendicular to the axial direction of the shaft member 36, the shape of one end of the shaft member 36 and the gear fitting hole 34 is non-circular.

In the present embodiment, the lever fitting hole 44 does not have the flat surface 442. In a cross section perpendicular to the axial direction of the shaft member 36, the lever fitting hole 44 has a D-shape. The shape of the lever fitting hole 44 corresponds to the shape of the other end of the main shaft portion 37.

The other end of the shaft member 36 and the lever fitting hole 44 are fitted together such that the flat surface 373 and the flat surface 441 face each other. This restricts the relative rotation between the shaft member 36 and the lever 40. Thus, in a cross section perpendicular to the axial direction of the shaft member 36, the other end of the shaft member 36 and the lever fitting hole 44 have a non-circular shape.

### Fifth Embodiment

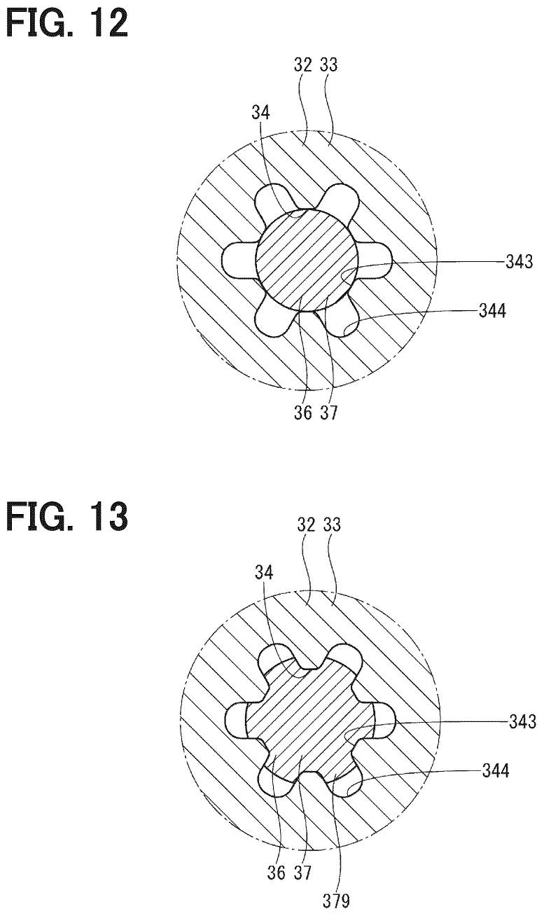

A part of the reaction force imparting device of a fifth embodiment is shown in FIGS. 12 and 13. The fifth embodiment differs from the first embodiment in the configurations of the shaft member 36, the reduction gear 32, and the like.

The reduction gear 32 has a gear fitting hole 34 as a fitting hole into which one end of the shaft member 36 fits. The gear fitting hole 34 has a main hole portion 343 and a hole recess portion 344 formed to be recessed radially outward from the main hole portion 343. The shaft member 36 has a main shaft portion 37 located inside the main hole portion 343, and a shaft protruding portion 379 that protrudes radially outward from the main shaft portion 37 due to plastic deformation and fits into the hole recess portion 344.

More specifically, six hole recess portions 344 are formed at equal intervals in the circumferential direction of the main hole portion 343. Further, six shaft protruding portions 379 are formed at equal intervals in the circumferential direction of main shaft portion 37 so as to fit into hole recess portions 344 (see FIG. 13).

Next, the crimping fastening of the reduction gear 32 to the shaft member 36 will be described.

First, one end of the main shaft portion 37 is inserted into the gear fitting hole 34 (see FIG. 12). At this time, the relative positions of the reduction gear 32 and the shaft member 36 in the rotational direction are adjusted. Next, one end of the shaft member 36 is crimped, and the shaft member 36 is plastically deformed, so that the shaft protruding portions 379 protrude radially outward from the main shaft portion 37 and fits into the hole recess portions 344 (see FIG. 13). According to this configuration, the crimping and fastening of the reduction gear 32 to the shaft member 36 is completed.

In the present embodiment, since the shaft protruding portion 379 is formed to fit into the hole recess portion 344, the relative rotation between the shaft member 36 and the reduction gear 32 can be reliably restricted.

As described above, in the present embodiment, the reduction gear 32 has the gear fitting hole 34 as a fitting hole into which one end of the shaft member 36 fits. The gear fitting hole 34 has a main hole portion 343 and a hole recess portion 344 formed to be recessed radially outward from the main hole portion 343. The shaft member 36 has a main shaft portion 37 located inside the main hole portion 343, and a shaft protruding portion 379 that protrudes radially outward from the main shaft portion 37 due to plastic deformation and fits into the hole recess portion 344.

Therefore, the reduction gear 32 and the shaft member 36 can be fastened by crimping while adjusting the relative positions of the reduction gear 32 and the shaft member 36 in the rotational direction. Furthermore, after crimping, the relative rotation between the shaft member 36 and the reduction gear 32 can be reliably restricted.

### Sixth Embodiment

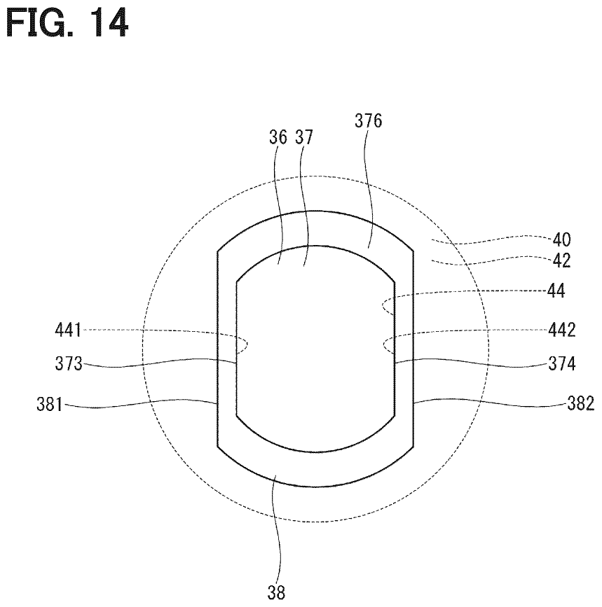

FIG. 14 shows a part of the reaction force imparting device of a sixth embodiment. The sixth embodiment differs from the first embodiment in the configuration of the shaft member 36.

In the present embodiment, the shaft member rotation restricting portion 38 is formed to have a two-face width shape.

More specifically, the shaft member rotation restricting portion 38 further has a flat surface 382. The flat surface 382 is formed parallel to the flat surface 381 with the axis of the shaft member 36 sandwiched between the flat surface 382 and the flat surface 381. As a result, the shaft member rotation restricting portion 38 is formed so that its outer shape has a two-face width shape when viewed from the axial direction (see FIG. 14).

By fitting the jig hole portion of a jig having a jig hole portion shaped to correspond to the outer shape of the shaft member rotation restricting portion 38 into the shaft member rotation restricting portion 38, the rotation of the shaft member 36 can be regulated even if a rotational force around the axis acts on the shaft member 36.

### Other Embodiments

In the above-described embodiment, an example has been shown in which the shape of one end of the shaft member and the gear fitting hole, and the shape of the other end of the shaft member and the lever fitting hole are non-circular in a cross section perpendicular to the axial direction of the shaft member. In contrast to this configuration, in other embodiments, in a cross section perpendicular to the axial direction of the shaft member, either the shape of one end of the shaft member and the gear fitting hole, or the shape of the other end of the shaft member and the lever fitting hole may be non-circular. In addition, in a cross section perpendicular to the axial direction of the shaft member, the shape of one end of the shaft member and the gear fitting hole, and the shape of the other end of the shaft member and the lever fitting hole may be circular.

In other embodiments, the wall surface of the floor panel of the vehicle to which the reaction force imparting device and the accelerator device are attached may not be formed parallel to the yz plane. That is, the wall surface of the floor panel may be formed at any angle with respect to the vehicle.

Furthermore, the reaction force imparting device and accelerator device according to the present disclosure can also be applied to transports other than vehicles.

Features of the present disclosure are shown below.

### Disclosure 1

A reaction force imparting device for imparting a reaction force against a driver's depression force to a pedal (70) of an accelerator device having a pedal that is depressed by a driver includes
an actuator (20) configured to generate a driving force when energized;
a power transmission unit (30) having a reduction gear (32) for reducing a speed of a driving force from the actuator and a shaft member (36) connected to the reduction gear, and
a lever (40) having one end connected to the shaft member, which rotates by a driving force from the actuator reduced in speed by the reduction gear, and imparts the reaction force to the pedal or an arm (80) which rotates together with the pedal.

The reduction gear and the lever are fastened to both ends of the shaft member by crimping.

### Disclosure 2

In the reaction force imparting device according to disclosure 1, the reduction gear has a gear fitting hole (34) into which one end of the shaft member fits.

The lever has a lever fitting hole (44) into which the other end of the shaft member fits.

In a cross section perpendicular to an axial direction of the shaft member, a shape of one end of the shaft member and the gear fitting hole, or a shape of the other end of the shaft member and the lever fitting hole is non-circular.

### Disclosure 3

In the reaction force imparting device according to disclosure 2, one end of the shaft member and the gear fitting hole, or the other end of the shaft member and the lever fitting hole, have at least one flat surface (371, 372, 373, 374, 341, 342, 441, 442) at a position facing each other.

### Disclosure 4

In the reaction force imparting device according to disclosure 1, at least one of the reduction gear and the lever has a fitting hole (34, 44) into which one end or the other end of the shaft member fits.

The fitting hole has a main hole portion (343) and a hole recess portion (344) formed so as to be recessed radially outward from the main hole portion.

The shaft member has a main shaft portion (37) located inside the main hole portion, and a shaft protruding portion (379) that protrudes radially outward from the main shaft portion due to plastic deformation and fits into the hole recess portion.

### Disclosure 5

In the reaction force imparting device according to any one of disclosures 1 to 4, at least one of the reduction gear or the lever has a rotation restricting portion (351, 352, 451, 452) that regulates the rotation of the reduction gear or the lever by abutting against a jig (101, 102) when a rotational force around the axis acts on the shaft member.

### Disclosure 6

In the reaction force imparting device according to any one of disclosures 1 to 5, the shaft member has a shaft member rotation restricting portion (38) at a portion other than both ends in the axial direction, which regulates the rotation of the shaft member by abutting against a jig (103) when a rotational force around the axis acts on the shaft member.

### Disclosure 7

In the reaction force imparting device according to disclosure 6, the shaft member rotation restricting portion is formed to have a D-cut shape or a two-face width shape.

### Disclosure 8

In the reaction force imparting device according to any one of disclosures 1 to 7, the shaft member has a seat surface (375, 376) that abuts against the reduction gear or the lever in the axial direction.

The reduction gear or the lever has a first flat surface (331, 411) that abuts against the seat surface, and a second flat surface (332, 412) that is parallel to the first flat surface.

Thus, the present disclosure is not limited to the above embodiments but can be implemented in various forms without departing from the scope thereof.

The present disclosure has been described based on the embodiments. However, the present disclosure is not limited to the embodiments and structures. The present disclosure also encompasses various modifications and variations within the scope of equivalents. Furthermore, various combination and formation, and other combination and formation including one, more than one or less than one element may be made in the present disclosure.

What is claimed is:

1. A reaction force imparting device for imparting a reaction force against a driver's depression force to a pedal of an accelerator device having a pedal that is depressed by a driver, the reaction force imparting device, comprising:
an actuator configured to generate a driving force when energized;
a power transmission unit having a reduction gear for reducing a speed of a driving force from the actuator and a shaft member connected to the reduction gear; and
a lever having one end connected to the shaft member, which rotates by a driving force from the actuator reduced in speed by the reduction gear, and imparts the reaction force to the pedal or an arm which rotates together with the pedal,
wherein
the reduction gear and the lever are fastened to both ends of the shaft member by crimping, and
the reduction gear has external teeth formed on a portion of its outer edge.

2. The reaction force imparting device according to claim 1, wherein
the reduction gear has a gear fitting hole into which one end of the shaft member fits, and
the gear fitting hole is formed on an opposite side of the reduction gear from the external teeth with respect to a center of the reduction gear when viewed in an axial direction of the shaft member.

3. The reaction force imparting device according to claim 1, wherein
the reduction gear has a gear fitting hole into which one end of the shaft member fits,
the lever has a lever fitting hole into which the other end of the shaft member fits, and
in a cross section perpendicular to an axial direction of the shaft member, a shape of one end of the shaft member and the gear fitting hole, or a shape of the other end of the shaft member and the lever fitting hole is non-circular.

4. The reaction force imparting device according to claim 3, wherein
one end of the shaft member and the gear fitting hole, or the other end of the shaft member and the lever fitting hole, have at least one flat surface at a position facing each other.

5. The reaction force imparting device according to claim 1, wherein
at least one of the reduction gear and the lever has a fitting hole portion into which one end or the other end of the shaft member fits,
the fitting hole portion has a main hole portion and a hole recess portion formed so as to be recessed radially outward from the main hole portion, and
the shaft member has a main shaft portion located inside the main hole portion, and a shaft protruding portion that protrudes radially outward from the main shaft portion due to plastic deformation and fits into the hole recess portion.

6. The reaction force imparting device according to claim 1, wherein
at least one of the reduction gear or the lever has a rotation restricting portion that regulates the rotation of the reduction gear or the lever by abutting against a jig when a rotational force around the axis acts on the shaft member.

7. The reaction force imparting device according to claim 1, wherein
the shaft member has a shaft member rotation restricting portion at a portion other than both ends in the axial direction, which regulates the rotation of the shaft member by abutting against a jig when a rotational force around the axis acts on the shaft member.

8. The reaction force imparting device according to claim 7, wherein
the shaft member rotation restricting portion is formed to have a D-cut shape or a two-face width shape.

9. The reaction force imparting device according to claim 1, wherein
the shaft member has a seat surface that abuts against the reduction gear or the lever in an axial direction, and
the reduction gear or the lever has a first flat surface that abuts against the seat surface, and a second flat surface that is parallel to the first flat surface.
